(19) United States
(12) Patent Application Publication
(10) Pub. No.: US 2019/0336803 A1
(43) Pub. Date: Nov. 7, 2019

(54) MULTIPLE-NOZZLE PULSE DISCHARGE DEVICE ON A SELF-PROPELLED BASE

(71) Applicant: PULSTECH OÜ, Tallinn (EE)

(72) Inventors: Vladimir Dmitry ZAKHMATOV, Kiev (UA); Ardo PÄRNA, Tallinn (EE); Allan VENTSEL, Tallinn (EE); Kalle KÖÖMNEMÄGI, Tallinn (EE)

(21) Appl. No.: 16/343,613

(22) PCT Filed: Mar. 10, 2017
(86) PCT No.: PCT/IB2017/051428

§ 371 Date: Apr. 19, 2019

(30) Foreign Application Priority Data
Jun. 6, 2016 (EE) P201600011

(51) Int. Cl. A62C 31/05; A62C 27/00; A62C 3/02; B05B 7/10

(52) U.S. Cl. CPC A62C 31/05; B05B 7/10; A62C 3/02; A62C 27/00

(57) ABSTRACT

The invention provides a method of generating a guidable vortex stream of an atomised mixture of a substance that is discharged as a salvo from a multiple-nozzle pulse discharge device, where the vortex stream fragments created in individual discharging nozzles that are part of the salvo are joined, the range and shape of the spread and effect area of the vortex stream that is dispersed to a relatively long distance as a uniform, large-scale front is shaped by the number of the discharging nozzles that are part of the salvo, their position with respect to each other, the choice of the active substance loaded inside the discharging nozzles, the sequence of initiation of the discharging nozzles or their groups and the time offset between the initiations.

### FIELD OF THE INVENTION

The invention mainly concerns fire extinguishing equipment and methods, but also the fields of environmental protection and protection of public order. More specifically, the invention is related to a multiple-nozzle pulse discharge device on a self-propelled base and a method for generating a guidable vortex stream of an atomised mixture of agent discharged as a salvo from the multiple-nozzle pulse discharge device.

### STATE OF THE ART

Over the last decades, fire extinguishing technology has been mainly developed by increasing the capacity of supplying a constant stream of extinguishing agent, resulting in a significant increase in the complexity and cost of the devices while bringing about only a relatively small improvement in the efficiency of the technology that can in many cases be insufficient compared to the intensity and the speed of the spread of fire. It can be said that the further development of technology based on the method of feeding extinguishing agent as a constant flow is insufficiently productive.

Today, a number of devices have been constructed all over the world making use of pulse discharge technology.

From the devices built so far, the principles of the multiple-nozzle pulse discharge method have seen the most complete application in the experimental 50-nozzled firefighting and rescue machine Impuls-3M built in Ukraine in the 1990s on the basis of a tank, the efficiency, functionality, and reliability of which are still unsurpassed. Even today, no real analogues to this machine exist in the world.

The main weakness of pneumatic pulse discharge devices is the insufficient discharge force of the pneumatic pulse and the small extinguishing distance. No pulse discharge device has so far applied the principles of the pulse discharge method in a sufficient and complex manner; as a result, the application of the method shows a large amount of unexploited potential.

A number of devices have also been developed based on the pulse atomisation method. Patent application No. WO2015100949 and utility model No. UA31518 disclose multiple-nozzle fire extinguishing devices based on pulse technology. No time offset is used for activating the nozzles in the known devices and methods, and the efficiency and various functional parameters of the solutions still remain significantly lower than can be attained using the method for generating a guidable vortex stream of an atomised mixture of agent discharged as a salvo from a multiple-nozzle pulse discharge device.

### SUMMARY OF THE INVENTION

The invention concerns a multiple-nozzle pulse discharge device on a self-propelled base and a method for generating a guidable vortex stream of an atomised mixture of agent discharged as a salvo from the multiple-nozzle pulse discharge device. The multiple-nozzle pulse discharge device comprises a discharge module, in turn comprising discharge nozzles and cassettes of active substance. The self-propelled base is a self-propelled vehicle and the discharge module is mounted on the carriage of the self-propelled vehicle. The self-propelled vehicle comprises a storage for cassettes where both full and empty active substance cartridges are stored, and the discharge module and cassette storage are connected to a cassette loading mechanism.

The purpose of the invention is, in general, to create, shape, and guide a gas dispersed vortex stream of micro particles of a liquid or gel-like active substance discharged as a salvo from multiple nozzles, whereas the range and shape of the spread and effect area of the vortex stream, as well as the intensity of the effective impact is formed mainly by the number of nozzles participating in the salvo, their mutual placement or the configuration of the selection of nozzles, choice of active substance, initiation sequence of the nozzles, and time offset between the initiations. The vortex stream fragments created in the nozzles participating in the salvo interact with each other, resulting in the creation of a single vortex stream that will mainly increase in the horizontal direction, in width and length, and increase less in the vertical direction when spreading as a single front in near-ground level atmosphere. The desired result can be achieved using either a single pulse discharge device or simultaneously using multiple pulse discharge devices, whereas at least one vortex stream with suitable parameters should be formed using each submodule, nozzle, or nozzle group of the device.

The goal of the invention is to provide significantly higher efficacy, effectiveness safety, economy, and other beneficial characteristics compared to so-called traditional fire extinguishing methods used today in the fields of application of the invention, such as the following fields:
The field of fire extinguishing, where these characteristics are achieved mainly through the capacity of significantly increased extinguishing intensity and the resulting extinguishing speed, significantly reduced specific extinguishing agent consumption, the possibility of using locally found natural inert materials, such as sand, earth, snow, as an extinguishing agent, the capacity of extinguishing fires from a safe distance, etc.
The field of environmental protection, where these characteristics are achieved mainly through the capacity of fast, efficient, and uniformly guided dispersion of environmental protection agents to relatively large distances and large areas, and the possibility of dispersing the agent to relatively large distances will, in many cases, such as in case of chemical contamination on the ground or oil contamination in a body of water, prevent or reduce secondary contamination caused by decontamination work.
The field of protection of public order, personal safety, etc., where these characteristics are achieved mainly through the capacity of designing and implementing non-lethal safety devices that are extremely efficient and non-threatening to life and health.

The invention describes the formation of the intensity of the effect of a gas dispersed vortex stream of an atomised mixture of a substance discharged as a salvo from a multiple-nozzle pulse discharge device, as well as the range and shape of the spread and effect area of the vortex stream by the number of discharge nozzles participating in the salvo, their position with respect to each other, the choice of discharged substance(s), the sequence of initiation of the discharge nozzles, and the time offset between the initiations. The vortex stream fragments created in the nozzles participating in the salvo interact with each other, resulting in the creation of a single vortex stream that will, for example, mainly increase in the horizontal direction, in width and length, and increase less in the vertical direction when spreading as a single front in near-ground level atmosphere. The desired result can be achieved simultaneously using either a single or multiple pulse discharge devices, whereas at least one vortex stream with suitable parameters should be formed using each submodule of each pulse module.

In addition to discharging a vortex stream to a relatively large distance and area, the application of this method also enables designing devices where the recoil caused by the detonation of the propellant charge is several times smaller than the recoil caused by an equivalent propellant charge in another pulse discharge device, enabling the construction of devices with a relatively lighter structure that are relatively more powerful.

### LIST OF DRAWINGS

The preferred embodiments of the invention will now be described with reference to the accompanying figures, whereas the figures depict the following:

FIG. 1: shows a general view of a multiple-nozzle pulse discharge device on a self-propelled base;

FIG. 2: shows a top sectional view of the cassette storage;

FIG. 3: shows a side view of a cassette with a cut-out;

FIG. 4: shows the changes in the shape of the vortex stream caused by changes in initiation intervals;

FIG. 5: shows a method for generating an optimum vortex stream.

### EXEMPLARY EMBODIMENT OF THE INVENTION

In one aspect, the invention provides a multiple-nozzle pulse discharge device on a self-propelled base used for generating, shaping, and guiding the gas dispersed vortex stream of a diffused mixture of an atomised active substance and discharge gases.

### The Device

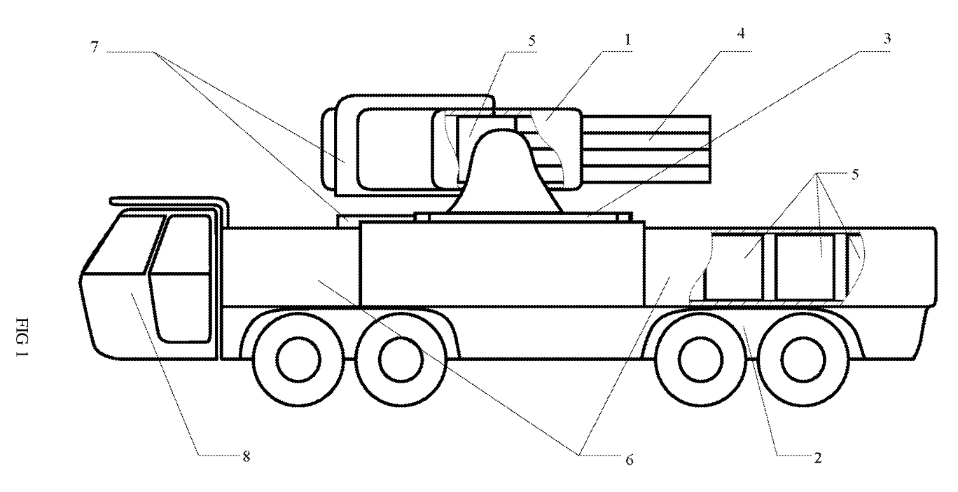

The pulse discharge device comprises a pulse discharge module (1) mounted on a self-propelled base, or a self-propelled vehicle (2), using a carriage (3) provided with shock absorbers, as shown in FIG. 1. In a preferred embodiment of the invention, the self-propelled device is based on a platform moving on wheels and having a strong structure that can tolerate the load of the recoil accompanying the discharge or the vortex stream. In one embodiment of the invention, the self-propelled base is the carriage of a large-calibre self-propelled cannon used in the military field. In this case, the device will also use the standard horizontal aiming system of the self-propelled base.

In a preferred embodiment of the invention, the discharge module (1) comprises discharge nozzles (4) and active substance cassettes (5), whereas the self-propelled vehicle (2) has an active substance cassette storage (6) for storing full and empty active substance cassettes (5), and the discharge module (1) and the base of the self-propelled vehicle (2) are equipped with an active substance cassette (5) loading mechanism (7) for replacing empty active substance cassettes (5) with full active substance cassettes (5). The control centre of the device, also known as the vortex stream control centre, is located in the control cabin (8).

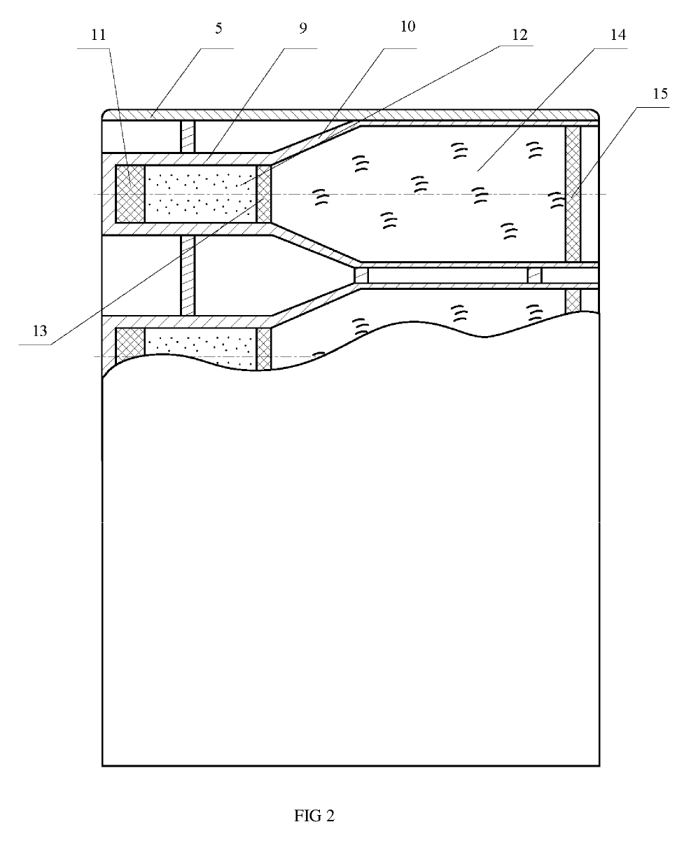

An active substance cassette (5), as shown in FIG. 2, comprises a detonation chamber (9) and an active substance chamber (10). In one embodiment of the invention, the rear part of the detonation chamber (9) comprises a capsule containing an initiator (11) and a propellant charge (12). In an alternative embodiment of the invention, the initiator (11) and propellant charge (12) are located in the rear part of the detonation chamber (9) without a capsule. The initiator (11) and the propellant charge (12) form the discharge cartridge. The detonation chamber (9) is connected to the active substance chamber (10), whereas a hermetic partition cap (13) is provided between the detonation and active substance chambers (9,10). The active substance chamber (10) contains the active substance (14) and is connected to the discharge nozzle (4), whereas a front cap (15) is provided between the active substance chamber (10) and the discharge nozzle (4), as shown in FIG. 2. In an alternative embodiment of the invention, the active substance (14) is located in a special container tightly fitting inside the active substance chamber and easily breakable by the force of the discharge gases. In this case, the hermetic caps are replaced by the end walls of the container.

The discharge nozzles (4) and the active substance cassettes (5) form the vortex stream formation module. The detonation chamber (9), active substance chamber (10), and discharge nozzle (4) together form a joint tube, and a set of joint tubes inside a multiple-nozzle pulse discharge device. The detonation chambers (9) are short tubes, in a preferred embodiment having a round cross-section, the length of which is at least 1.2 times larger than their diameter. The front part of the detonation chamber (9) is rigidly connected to the active substance chamber (10) by the means of a connection sleeve. In a preferred embodiment of the invention, the detonation chamber (9) is fitted sufficiently tightly within a sliding sleeve inside the rear support wall, giving it a certain degree of freedom of movement on the longitudinal axis in relation to the support wall of the joint tube, limited by certain limiters. The detonation chamber (9) is made of a standard metal tube with a round cross-section, but can in alternative embodiments of the invention be made of other materials, such as plastic.

The discharge nozzles (4) have a larger diameter than the detonation chamber (9), similar to the active substance chamber (10); in a preferred embodiment, they are formed from tubes with a round cross section that are tightly connected to the active substance chamber (10) inside the active substance cassette (5). The active substance cassettes (5) comprise a honeycomb structure of filled/loaded and sequentially located detonation and active substance chambers (9, 10). The active substance chambers (10) have cavities symmetrical to the longitudinal axis of the active substance cassette (5), the longitudinal axis of which coincides with the longitudinal axis of the respective discharge nozzle (4) when the active substance cassette (5) is connected to the nozzle.

The partition cap (13) between the detonation chamber (9) and active substance chamber (10) and the front cap (15) between the active substance chamber (10) and discharge nozzle (4) are broken by the discharge gases created by the detonation of the propellant charge. In a preferred embodiment, each joint tube is fitted with at least one shock absorber to reduce the transmission of the impulse created by the detonation of the propellant charge to the structure in the form of recoil.

In one embodiment of the invention, a recoil absorber is fitted to the support wall between the sliding sleeve and the limiter attached to the capsule comprising the propellant charge (12) and the initiator (11) located inside the detonation chamber (9), while another recoil absorber is located on the other side of the support wall, that is, in front of the support wall, between the connection sleeve between the detonation and active substance chamber (9, 10).

The sets of joint tubes formed from a detonation, active substance and discharge nozzle (9, 10, 4) are located parallel and relatively close to each other, for instance, in such a manner that the distance between two joint tubes is approximately equal to or smaller than the diameter of the joint tube. The joint tubes are placed in a so-called chequerboard pattern or in another configuration in the end-view plane.

In one embodiment of the invention, no active substance cassettes (5) are used and each joint tube is an undivided whole. In this embodiment, active substance (14) previously poured into containers is loaded inside the discharge nozzle (4) from the front of the nozzle, similar to a mortar, and propellant cartridges are loaded from the back, connecting them to the rear part of the detonation chamber (9) inside a special capsule or placing them directly inside the detonation chamber (9).

The propellant cartridge is a cartridge combining the propellant charge (12) and an initiator (11), containing high combustion gunpowder or a low explosive material as the propellant; in a preferred embodiment of the invention, the initiator (11) is an electrically actuated initiator fitted with an electric blocker, so that it is only activated in the case of a non-standard electric pulse.

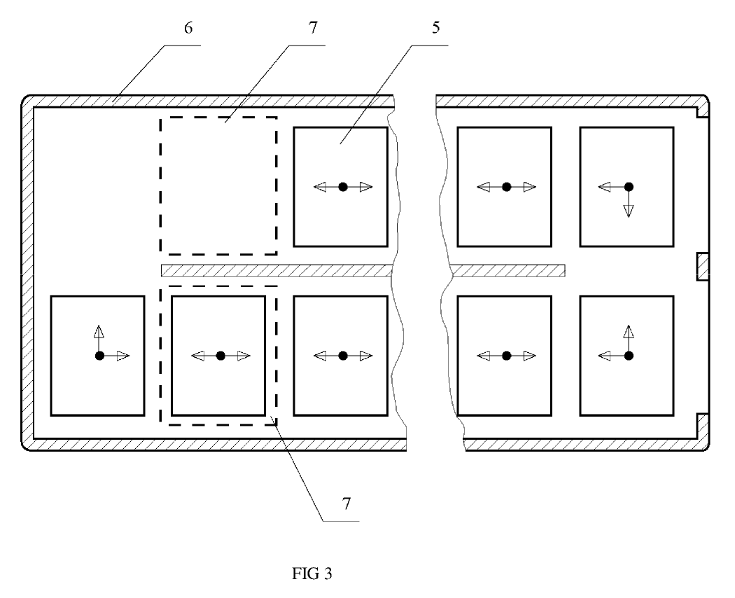

In a preferred embodiment of the invention, the pulse discharge device is provided with an active substance cassette (5) loading mechanism (7) as shown in FIG. 3 to ensure the rapid and speedy replacement and reloading of the supply of active substance cassettes (5), whereas the mechanism is provided with an active substance cassette supply (6) located below the plane of the pulse discharge device and equipped with special transportation means for facilitating the circulation of active substance cassettes (5).

In a preferred embodiment of the invention, the pulse discharge module is provided with a set of telescopic tubes (sleeves) between the active substance cassettes (5) and discharge nozzles (4) for connecting the active substance cassettes (5) to the discharge nozzles (4), enabling the active substance cassette (5) to move away from the set of discharge nozzles (4) and then back close to the nozzles without losing a tight seal. The rear, propellant cartridge side of the active substance cassette (5) is supported on a support plate, on the front surface of which are located sliding contacts, remote contacts, or other similar contacts.

In a preferred embodiment of the invention, the complete pulse discharge module is mounted on a sliding base inside a turning carriage (3) with shock absorbers provided between the parts moving relative to each other to enable reducing the recoil caused by generating a vortex stream.

The control cabin (7) is protected from mechanical damage, heat, dust, smoke, other harmful gases, radiation, etc. The vortex stream control centre is provided with hardware and software that enable the on-board computer provide the operator with optimum usage schemes and aiming information based on the provided algorithms and using information received from various sensors, such as video and thermal cameras, etc., to enable the operator to operate the device in an efficient and prompt manner.

### Method

The method for generating a guided vortex stream of atomised mixture of substance discharged as a salvo from a multiple-nozzle pulse discharge device involves joining the vortex stream fragments generated in individual discharge nozzles (tubes) participating in the salvo into a single vortex stream reaching a relatively large distance (significantly, i.e. several times larger than generated by so-called traditional methods) as a single large front, the range and shape of the spread and effect area of which is formed by the number of discharge nozzles (tubes) participating in the salvo, their position with respect to each other, the choice of active substance loaded inside the discharge nozzles (tubes), the sequence of initiation of the discharging nozzles (tubes) or their groups, and the time offset between the initiations.

The range (distance) (L) and area (S) of the spread and effect area of the front of the gas disperse vortex stream containing micro particles of the active substance generated by the pulse discharge device is shaped as follows:

The vortex stream is generated as a result of a salvo of a number of similar and closely placed discharge nozzles (tubes) by varying the number (n) of the discharge nozzles (tubes) participating in the salvo, on the condition that the total amount of discharged active substance and total size of the propellant charge used in each salvo remain constant, where the relationship between L and S with the value of n can be graphically represented by a sigmoid curve (a so-called S-curve),

where the increase of L and S is relatively smaller in the case of relatively small values of n (e.g. from 1 to 3);
where the increase of L and S is maximally large in the case of medium values of n (e.g. from 4 to 8);
and where the increase is reduced again in the case of large values of n;
and where the minimum and maximum values of L and S occurring in the case of values of n most likely used in real-life applications (e.g. from 1 to 20) differ by 4 to 5 times, as a result of which the respective maximum parameters of a device designed based on the method of the invention will also differ (are larger) by just as much from the respective parameters of another similar (i.e. discharging a similar amount of active substance using a propellant charge of similar power) pulse discharge device.

The values of L and S are adjusted as follows: a vortex stream is generated by a salvo from a number of similar and closely located discharge nozzles (tubes) by varying the number (n) of discharge nozzles (tubes) participating in the salvo, on the condition that the amount of discharged active substance and the size of the propellant charge remains constant in each discharge nozzle (tube) over all salvoes, and where the relationship between L and S to n is expressed by the following logarithmic function:

L=k(L₁+L₂(logₐ(n));

S=k(S₁+S₂(logₐ(n));

where:
L—range (distance) of the spread of the front of the effect area of the vortex stream in metres;
L₁ and L₂—components of the formula corresponding to specific conditions, in metres;
S—surface area of the effect area of the vortex stream in square metres;
S₁ and S₂—components of the formula corresponding to specific conditions, in square metres;
n—number of discharge nozzles (tubes) participating in the salvo;
k—coefficient, the value of which is based on the used active substance and other factors;
the value of k can vary in the range of approximately 0.3-1.5;
a—base of the logarithm, the value of which depends on experimental conditions;
whereas in the case of the tested equipment where the goal was to maximize the values of L and S, the following approximate empirical relationships have been found and simplified to be linear (that can be considered correct only in the case of relatively moderate values of n (maximum 10-12)):

L=k(25+8(n−1));

S=k(60+80(n−1)).

In order to generate a single vortex stream and maximize the values of L and S, the discharge nozzles (tubes) participating in the salvo are located relatively close to each other, e.g. so that each discharge nozzle (tube) is located at a distance approximately equal to or smaller than the diameter of the discharge nozzle (tube) from the nearest discharge nozzle (tube).

The discharge nozzles (tubes) participating in the salvo are arranged in a straight line, a jagged line, or another kind of line.

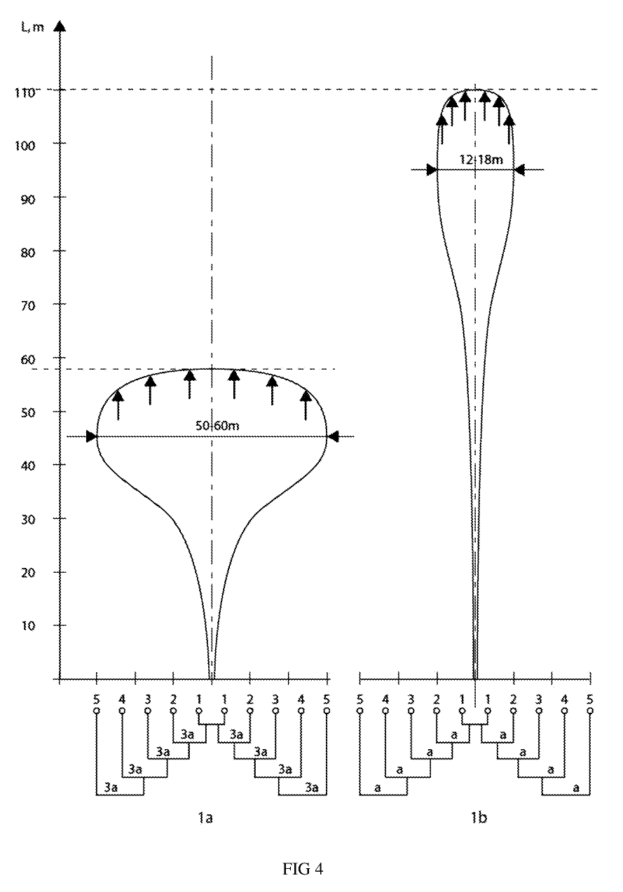

As shown in FIG. 4, maximum values of L and S are achieved when the discharge nozzles (tubes) arranged in a line and participating in a salvo are initiated in such a manner that the initiation starts from the centre and proceeds towards the outside (with a time offset) and where the discharge nozzles (tubes) or groups are initiated with a relatively small time interval that can be from the fraction of a millisecond to several hundred millisecond (e.g. in the range of 0.5-500 ms), and where in addition to maximizing the values of L and S, another effect caused by such time interval for the initiation of discharge nozzles (tubes) or their groups is a significant (even by several times) reduction of the recoil caused by the detonation of the propellant charge (compared to the recoil produced by another similar pulse discharge device).

The spread characteristics of the effect area of the vortex stream are shaped as follows:

the maximum width of the vortex stream front is achieved by arranging the discharge nozzles (tubes) participating in the salvo in a line and initiating the nozzles in such a manner that the initiation begins from the centre and proceeds towards the outside, and the time interval between the initiation of discharge nozzles (tubes) or their groups is relatively large;
and the maximum spread (range) of the vortex stream front is achieved by arranging the discharge nozzles (tubes) participating in the salvo in a line and initiating the nozzles in such a manner that the initiation begins from the centre and proceeds towards the outside, and the time interval between the initiation of discharge nozzles (tubes) or their groups is relatively small, approximately three times smaller than the value for maximizing the width of the front;
where the uniform spread of the vortex stream effect area front in the form of a sector extending in an approximately linear manner is achieved by arranging the discharge nozzles (tubes) participating in the salvo in a line and initiating the nozzles in such a manner that the initiation begins from the centre and proceeds towards the outside, and the time interval between the initiation of discharge nozzles (tubes) or their groups is increased approximately twofold for each initiation compared to the previous initiation;
where the variation of the time interval between the initiation of discharge nozzles (tubes) or their groups changes the value of the coefficient k in the formulas for L and S above by approximately between +/−30-40% or more.

The minimum number of discharge nozzles (tubes) or groups participating in a salvo is 2 and the upper limit for this number in real-life conditions is 120 or more; the discharge nozzles (tubes) forming a single group are initiated simultaneously or sequentially, separated by micro intervals, or using another scheme.

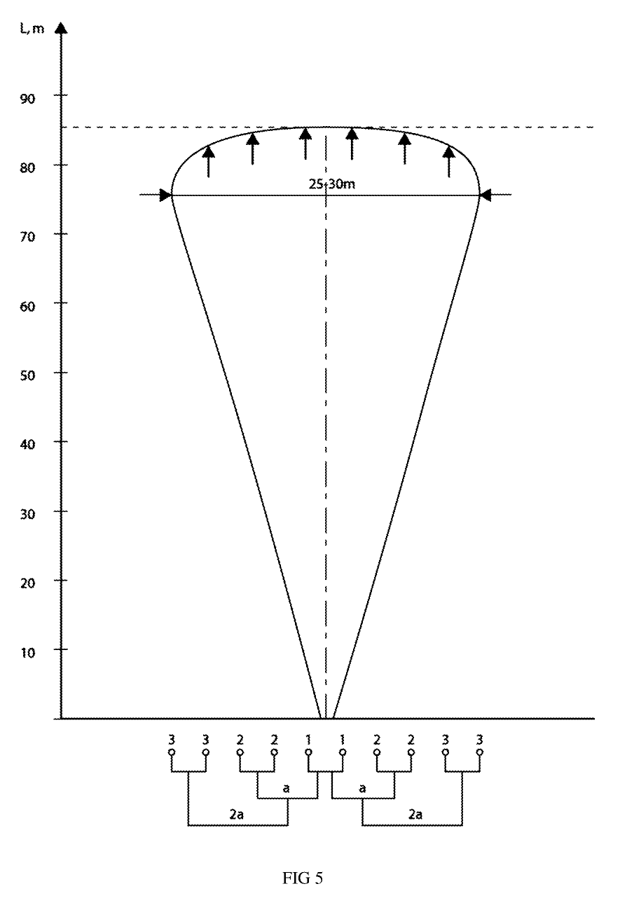

Optimum initiation time intervals (T) are determined based on the number of discharge nozzles (tubes) participating in the salvo, the number of discharge nozzle (tube) groups, and the number of discharge nozzles (tubes) in each group, as shown in FIG. 5 and exemplified by the following configurations:

if the salvo involves groups of discharge nozzles (tubes), each consisting of 2-10 discharge nozzles (tubes), then the interval T within the groups is in the range of 1-50 milliseconds (ms), while the interval T between groups is in the range of 2-150 ms;
if the salvo involves 2-11 discharge nozzles (tubes), the T between discharge nozzles (tubes) is in the range of 1-25 ms;
if the salvo involves 4 or more discharge nozzles (tubes) in groups of 2-3 discharge nozzles (tubes), the T between groups is in the range of 1-20 ms and the T within the group is 1-15 ms;
if the salvo involves 9 or more discharge nozzles (tubes) in groups of 2-3 discharge nozzles (tubes), the T between groups is in the range of 3-30 ms and the T within the group is 2-15 ms;
if the salvo involves 8-10 discharge nozzles (tubes) in groups of 4-5 discharge nozzles (tubes), the T between groups is in the range of 4-40 ms and the T within the group is 2-15 ms;
if the salvo involves 12-18 or more discharge nozzles (tubes) in groups of 6-7 discharge nozzles (tubes), the T between groups is in the range of 4-50 ms and the T within the group is 2-15 ms;
and where in a real firefighting situation, the suitable time interval between salvoes is in the range of 4-180 or more seconds, depending on the spread of the fire, configuration, distance from the extinguishing device and other factors.

In the case of applying the method for extinguishing fires for the purpose of maximally fast, efficient, and permanent extinguishing of the fire, an optimum assortment and sequence of use of fire extinguishing agents (FEA) will be selected based on the characteristics of the fire being extinguished, whereas an exemplary optimum configuration for extinguishing a fire occurring in complex real-life conditions involves using a 50 nozzle device as follows: two initial salvoes, 10 nozzles each, using fire extinguishing powder (the vortex stream L value of which is relatively larger than provided by other FEAs available, reaching 60-120 m or more), allow suppressing larger flames from a distance and then move the equipment closer to the fire zone; followed by two salvoes, 10 nozzles each, using water or extinguishing gel from a distance of 25-70 m, for the main extinguishing effect—i.e. cooling down hot glowing surfaces; third, a single salvo from 10 nozzles using a water and foaming agent mixture from a distance of 5-25 m to isolate the burning surfaces from access to oxygen—to completely extinguish the fire and prevent re-ignition.

When designing real devices based on this method, algorithms containing the respective configurations for the initiation of the nozzles (tubes) will be provided for the efficient control of the device, enabling the on-board computer provide the operator with optimum usage schemes and aiming information, taking into account various parameters, such as air and wind characteristics, etc., and using information received from various sensors (such as video and thermal cameras, etc.) to enable the operator to operate the device in an efficient and prompt manner.

The development of the disclosed method was based on theoretical and empirical studies of the creation and spread of gas disperse vortex streams to relatively large distances in multiphase environments, and effect processes developing in the course of the spread of the stream.

The invention is of increasing importance, as it enables making a significant leap in the development of its main areas of application, one of the most important ones is firefighting.

What is claimed is:

1. A multiple-nozzle pulse discharge device on a self-propelled base, comprising a discharge module (1) comprising at least one discharge nozzle (4) and at least one active substance cassette (5), wherein:
the active substance cassette (5) comprises a detonation chamber (9) and an active substance chamber (10); and
the discharge nozzle, detonation chamber, and active substance chamber (4, 9, 10) combine to form a joint tube.

2. The pulse discharge device of claim 1, wherein:
the discharge nozzle (4) and active substance cassette (5) form a vortex stream formation module that is configured to generate a vortex stream
the self-propelled base is a self-propelled vehicle (2) comprising wheels; and
the self-propelled base is configured to withstand a load generated by generation of the vortex stream.

3. The pulse discharge device of claim 1, further comprising a storage (6) for the at least one active substance cassette, wherein the discharge module (1) and the base of the self-propelled vehicle (2) comprise a loading mechanism (7).

4. The pulse discharge device of claim 1, further comprising a vortex stream control centre located in a control cabin (8).

5. The pulse discharge device of claim 1, wherein:
the detonation chamber (9) comprises an initiator (11) and a propellant charge (12)
the active substance chamber (10) comprises an active substance (14); and
the detonation chamber (9) and the active substance chamber (10) are rigidly connected to each other.

6. The pulse discharge device of claim 5, wherein the active substance (14) is located in a container made from a breakable material inside the active substance chamber (10).

7. The pulse discharge device of claim 5, wherein the active substance (14) is located inside the chamber (10) in a compact form and the end of the chamber (10) is sealed with a hermetic cap made from a breakable material.

8. The pulse discharge device of claim 5, wherein a rear part of the detonation chamber (9) contains a capsule comprising the initiator (11) and the propellant charge (12).

9. The pulse discharge device of claim 1, wherein the detonation chamber (9) is a tube with a round cross-section, the length of which exceeds its diameter by at least 1.2 times.

10. The pulse discharge device of claim 1, wherein:
the discharge nozzle (4) is a tube with a round cross-section and has a diameter that is larger than a diameter of the detonation chamber (9);
the discharge nozzle (4) is connected to the active substance chamber (10) of the active substance cassette (5); and
the joint tube further comprises at least one shock absorber.

11. The pulse discharge device of claim 1, comprising a plurality of said discharge nozzles, detonation chambers, and active substance chambers that are combined to form a plurality of said joint tubes, wherein the joint tubes are arranged parallel to each other, such that each of said joint tubes is located at a distance ranging from about equal to less than the diameter of a neighboring joint tube.

12. The pulse discharge device of claim 1, further comprising a cassette loading mechanism (7) comprising a cassette storage (6).

13. The pulse discharge device of claim 1, wherein the pulse discharge device is mounted on a sliding base that is movable back and forth on a carriage (3), and which comprises at least one shock absorber.

14. A method for generating a guidable vortex stream of an atomised mixture of agent discharged as a salvo from the multiple-nozzle pulse discharge device, wherein a range (distance) (L) and area (S) of a spread and effect area of a front of the gas dispersed vortex stream containing microparticles of the active substance generated by the pulse discharge device is shaped by generating a vortex stream by the means of a salvo of a number of similar discharge nozzles located close to each other and varying the number (n) of discharge nozzles participating in a volley, conditioned on a total amount of discharged active substance and total size of the propellant charge used in each salvo remaining constant;
where a relationship of L and S to the value of n is graphically depicted using a sigmoid curve, where at relatively low values of n, in the range of 1-3, an increase of L and S is relatively small, where at medium values of n, in a range of 4-8, an increase of L and S is largest, and where at larger values of n, an increase of L and S is slowed; and where within the range of the values of n occurring in real usage situations, in a range of 1-20, respective minimum and maximum values of L and S differ from each other 4 to 5 times and respective maximum parameters of a device designed based on the method of the invention also differ by just as much from respective parameters of another equivalent pulse discharge device.

15. The method of claim 14, wherein the values of L and S are adjusted by generating a vortex stream by the means of a salvo from a number of similar and closely located discharge nozzles by varying the number (n) of discharge nozzles participating in the salvo, conditioned on the amount of discharged active substance and the size of the propellant charge remaining constant in each discharge nozzle over all salvoes, and where a relationship between L and S to n is expressed by the following logarithmic function:
L=k(L1+L2(log a(n));
S=k(S1+S2(log a(n));
where:
L is a range (distance) of the spread of the front of the effect area of the vortex stream in metres;
L1 and L2 are components of the formula corresponding to specific conditions, in metres;
S is a surface area of the effect area of the vortex stream in square metres;
S1 and S2 are components of a formula corresponding to specific conditions, in square metres;
n is a number of discharge nozzles (tubes) participating in the salvo;
k is a coefficient ranging from about 0.3 to about 1.5;
a is a base of the logarithm, the value of which depends on experimental conditions;
where an empirical linear simplified approximate relationships are as follows:
L=k(25+8(n−1)); and
S=k(60+80(n−1)).

16. The method of claim 15, wherein to generate a single vortex stream and maximize the values of L and S, the discharge nozzles participating in the salvo are located relatively close to each other, e.g. so that each discharge nozzle is located at a distance approximately equal to or smaller than the diameter of the discharge nozzle from the nearest discharge nozzle.

17. The method of claim 14, wherein the discharge nozzles participating in the salvo are arranged in a straight line, a jagged line, or another kind of line.

18. The method of claim 14, wherein maximum values of L and S are achieved by initiating the discharge nozzles forming a part of a line participating in the volley by starting initiation from the centre and proceeding outwards with a time offset and by initiating the discharge nozzles or groups of discharge nozzles with a relatively small time interval in the range of 0.1-1000 ms.

19. The method of claim 14, wherein spread characteristics of the effect area of the vortex stream are shaped as follows:
a maximum width of the vortex stream front is achieved by arranging the discharge nozzles participating in the salvo in a line and initiating the nozzles in such a manner that the initiation begins from the centre and proceeds outwards, and a time offset between the initiation of discharge nozzles or their groups is relatively large;
a maximum spread (range) of the vortex stream front is achieved by arranging the discharge nozzles participating in the salvo in a line and initiating the nozzles in such a manner that the initiation begins from the centre and proceeds outwards, and the time offset between the initiation of discharge nozzles or their groups is relatively small, being approximately three times smaller than the value for maximizing the width of the front;
a uniform spread of the vortex stream effect area front in the form of a sector extending in an approximately linear manner is achieved by arranging the discharge nozzles participating in the salvo in a line and initiating the nozzles in such a manner that the initiation begins from the centre and proceeds outwards, and the time offset between the initiation of discharge nozzles or their groups is increased approximately twofold for each initiation compared to the previous initiation;
a variation of the time offset between the initiation of discharge nozzles or their groups changes the value of the coefficient k in the formulas for L and S disclosed in claim 2 by approximately between +/−30-40% or more.

20. The method of claim 14, wherein a minimum number of discharge nozzles or groups participating in a salvo is 2 and the upper limit for this number is 120 or more, and discharge nozzles forming a single group are initiated simultaneously or separated by microintervals, sequentially, or using another scheme.

21-23. (canceled)
